(19) United States
(12) Patent Application Publication
(10) Pub. No.: US 2003/0163906 A1
(43) Pub. Date: Sep. 4, 2003

(54) Oriented sign clip for mounting on label holder

(76) Inventor: Richard J. Wildrick, Hunlock Creek, PA (US)

Correspondence Address: SCHWEITZER CORNMAN GROSS & BONDELL LLP, 292 MADISON AVENUE - 19th FLOOR, NEW YORK, NY, 10017, US

(21) Appl. No.: 09/781,708

(22) Filed: Feb. 12, 2001

(51) Int. Cl. G09F 3/16; A44B 21/00

(52) U.S. Cl. 24/459; 40/658

(57) ABSTRACT

An extruded plastic sign clip is mounted on the top edge of a shelf-mounted label holder. The sign clip is employed optionally to mount a special offer or construction prominently on the front of the label holder. The clip has front and back walls, with resilient, flap-like retention ribs extending rearwardly from the front wall and a relatively smaller, soft friction rib being provided on the forwardly facing surface of the back wall. In order to insure that the sign clip is not mounted on the label holder in an improper (reverse) orientation, the front wall of the clip is joined to the back wall by downwardly and forwarding extending, preferably arcuate, wall. This both imparts an improved appearance to the clip, as well as making the accidental reverse orientation of the clip very unlikely. The clip is especially advantageous when used in connection with extruded plastic label holders formed of front and back panels joined along bottom edges and forming an upwardly opening label-holding pocket.

### BACKGROUND OF THE INVENTION

Merchandising outlets of all kinds utilize display shelving provided along the front edge of the shelving with a label holding device for receiving pricing labels in particular and to some degree other information bearing labels. One popular form of such label holder is an extruded plastic element having front and back panels flexibly joined along their bottom edges to form an upwardly opening pocket for the reception of labels. The front panel of the label holder is formed of clear plastic, so that the label is readily visible. The present invention is particularly useful in connection with label holders of this type, but is not necessarily limited thereto.

It is a common practice in many stores to provide special attention-catching signs calling customers' attention to special values, new items, etc. For this purpose, it is a common practice to employ a so-called sign clip that is slipped over the upper edge margin of the front panel of the label holder and enables a special sign, in the form of a paper slip or thin card, to be inserted between the front surface of the label holder and the front wall of the sign clip. The sign clip is provided on the inside of its front wall with one or more friction elements, positioned to engage the sign, which typically is printed on a small piece of paper or thin card.

Particularly in the case of large store chains and the like, sign clips may be installed by unskilled personnel, and a disturbingly high number of sign clips are installed with the “front” wall facing inward. In such cases, there is only a minimal grip on the sign card, which easily can be dislodged. Once dislodged, the entire effect of the sign card is lost. Since these sign cards are normally used only with transient “specials”, a dislodged sign card may never be replaced.

### SUMMARY OF THE INVENTION

Pursuant to the present invention, improvements in the design of the sign clip are made, such that it is difficult to install a sign clip in a reversely oriented manner. As a result, improper, reverse installations of the sign clips can be virtually eliminated, and it can be assured that sign cards will be effectively mounted on the front of the label holder, as intended. To this end, the sign clip, which includes one or more resilient, flap-like ribs extending rearwardly from its front wall, is formed in a manner that the front wall and the back wall are asymmetrically joined. Preferably, the upper wall of the clip, connecting the back and front walls thereof, extends forward and downward from the front wall. If the store clerk attempts to install the clip on the upper edge of the label holder in a reverse orientation, the mistake is instantly evident. Even if the clerk is exceptionally inattentive when initially installing the clip, when he or she later attempts to insert a sign card in the clip, the reverse orientation of the clip is immediately evident and will be corrected.

As an additionally advantageous feature, the back wall of the sign clip is provided with a small rib of soft, friction-imparting material for engagement with the back surface of the label holder panel. With conventional sign clips of the general type involved, it is typical to provide flexible ribs extending from the front wall of the clip and contacting the front surface of the label holder panel. This provides ample frictional engagement when the clip is installed, to prevent or minimize accidental dislodgment of the clip. However, after insertion of a sign card between the front surface of the label holder and the flexible ribs, the frictional grip of the clip on the label holder is significantly reduced and can sometimes be easily dislodged. With the device of the present invention, a friction-providing rib formed on the back wall of the clip remains in engagement with the back surface of the label holder panel after installation of a sign card, so that there is ample resistance to dislodgment of the clip after the sign card is installed.

For a more complete understanding of the above and other features and advantages of the invention, reference should be made to the following detailed description of a preferred embodiment of the invention.

### DESCRIPTION OF THE DRAWINGS

FIG. 1 is an end elevational view of a sign clip device of the prior art.

FIG. 2 is an end elevational view illustrating a sign clip device according to the invention installed on a label holder.

FIG. 3 is a partial perspective view of the sign clip device of FIG. 2.

FIG. 4 is a partial perspective view of a label holder installed on the front of a display shelf and mounting sign clip devices according to the invention.

### DESCRIPTION OF A PREFERRED EMBODIMENT OF THE INVENTION

Referring now to the drawings, the reference numeral 10 designates generally a typical display shelf for displaying merchandise. A label holder 11, formed of plastic material and comprising front and back panels 12, 13 respectively is shown to be mounted on the front edge 14 of the shelf, by means of an adhesive tape strip 15. The label holder 11 is of a well known type, with the front and back panels 12, 13 being joined along their bottom edges 16 and forming an upwardly opening pocket 17 for the reception of a price and/or information bearing label (not shown). At least the front panel 12 is formed of transparent material, such that a label received within the pocket 17 is visible from the front of the display shelf. In some cases, a short protective flange 18 extends forwardly from the upper edge of the back panel 13, forming a protective cover over the label pocket 17.

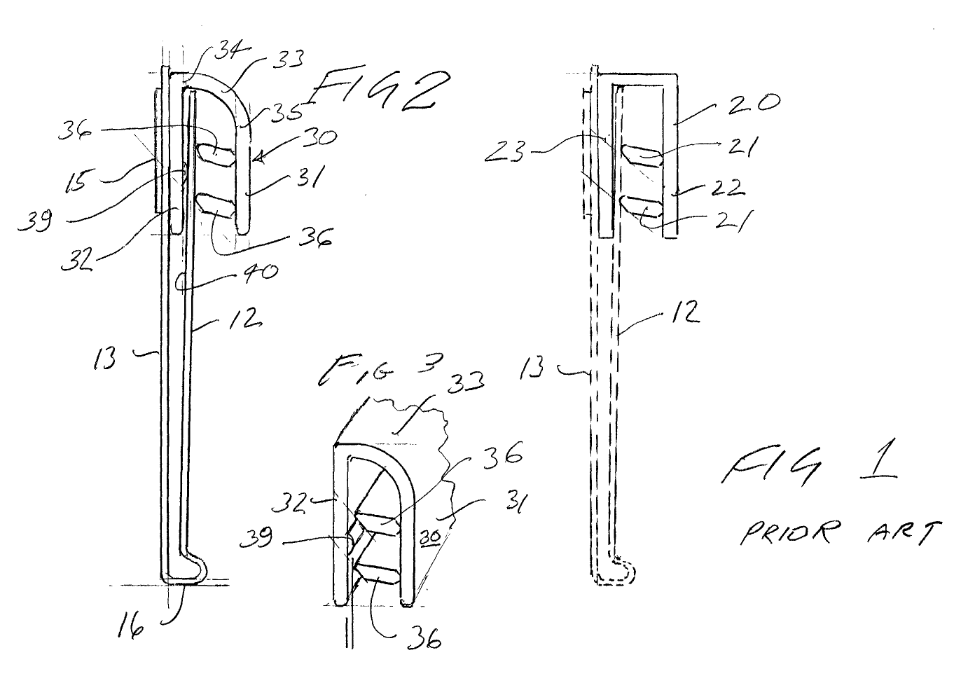

In order to emphasize special items, it is frequently desired to temporarily mount a “special” sign or card 19 at the front of the label holder 11. One of the ways of mounting the sign card 19 is through the use of a removably sign clip. FIG. 1 illustrates a form of sign clip 20 known in the prior art. The clip 20 is a short length of plastic material of inverted U-shaped configuration arranged to be applied with its downwardly oriented open end received over the upper edge margin of the label holder front panel 12, as shown in FIG. 1. One or more resilient ribs 21 project from one of the vertical walls 22 of the sign clip. These are intended to engage the label holder panel 12 for the purpose of allowing the upper edge of a sign card to be inserted upwardly into the sign clip and to be gripped and retained by the flexible ribs 21.

In practice, the sign clips 20 are frequently installed carelessly, by relatively unskilled store personnel, and there is almost an equal likelihood that the sign clip will not be installed in the orientation shown in FIG. 1, but will be installed with the “front” wall 22 on the inside of the label holder panel 12, with the retaining ribs extending forward and contacting the back surface of the panel 12. This causes two problems: First, when a sign card is inserted under the sign clip, it is gripped between two hard plastic surfaces, namely the front surface of the front panel 12 and the inside surface of the “back” wall 23 of the sign clip. This provides a very insecure holding for the sign card, and may well result in its dislodgment. Bearing in mind the essentially temporary nature of the sign card in the first instance, it is likely that the card, once dislodged, will not be reinstalled, and the whole purpose of its installation in the first instance is lost. A second problem results from the fact that, when the sign clip is installed in a “reverse” orientation, the retaining ribs 21 will displace the front panel 12 of the label holder a substantial distance forward from the back panel 13, creating a somewhat unsightly condition.

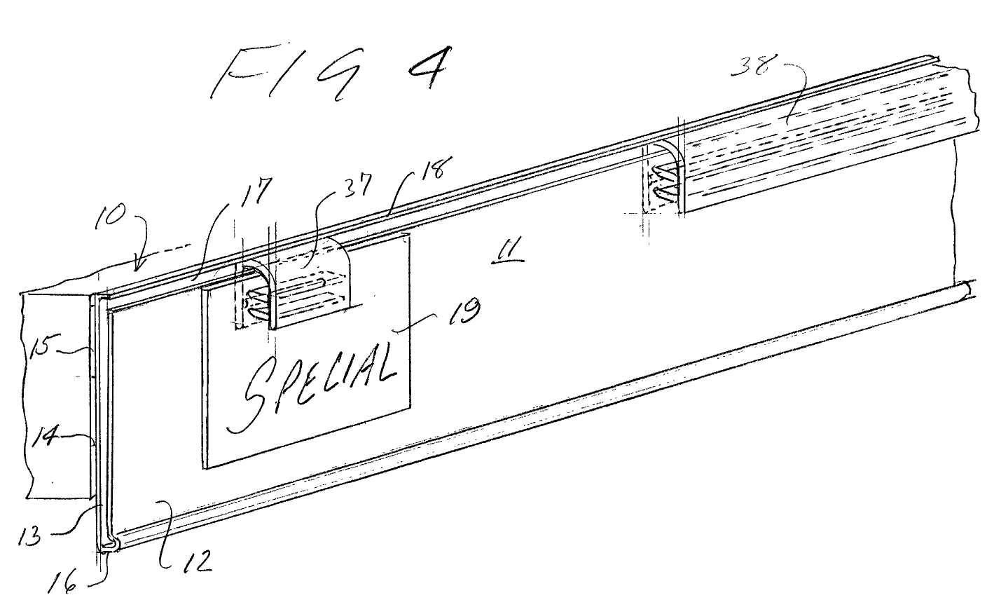

Pursuant to the present invention, a sign clip 30 is formed as an extruded section comprising generally parallel front and back walls 31, 32 which are joined asymmetrically by an upper wall 33. In the illustrated form of the invention, the upper wall 33 is of arcuate configuration, joining the back wall more or less at right angles and merging tangentially with the front wall 31. The specific configuration of the upper wall 33 is not critical. However, it is a feature of the invention that the upper wall 33 extend from its point of contact 34 with the back wall 32 in a direction downwardly and forwardly to its point of contact 35 with the front wall 31. As is evident in FIGS. 2 and 3, this provides for a significantly asymmetrical cross sectional configuration of the sign clip, with the upper extremity 35 of the front wall being substantially lower than the upper extremity of the back wall.

The body of the sign clip, comprising the front and back walls 31, 32 and the connecting upper wall 33, is formed of a rigid plastic material, such as rigid polyvinyl chloride. In the sign clip device of the invention, flexible, flap-like retaining ribs 36, of a co-extruded soft plastic material, extend rearwardly and slightly upwardly from the front wall 31 of the clip.

In a preferred embodiment of the invention, the walls of the sign clip may have a typical thickness on the order of 0.035 inch and are spaced apart approximately 0.130 inch. The resilient ribs 36 extend most of the distance from the front wall 31 to the back wall such that, when the clip is applied over the upper edge margin of a label holder front panel 12, the rearward extremities of the ribs 36 at least lightly engage the front surface of the panel 12 as shown in FIG. 2. The height of the back wall 32 in a typical case may be on the order of 0.400, and the height of the front wall 31 may be on the order of 0.270 inch, witih the bottom edges of the walls 31, 32 being approximately on the same level. It is understood, of course, that the specific dimensions are not critical, but only representative of a typical embodiment.

The clip, being an extruded section, may be provided at any length. As shown in FIG. 4, a clip 37 may be relatively short (e.g. one inch), or it may be provided in significantly greater lengths, as shown at 38 in FIG. 4. In some instances, the clip may be as long as the label holder 11 itself (typically forty-eight inches).

Pursuant to the invention, by providing for the significantly asymmetric external configuration of the clip, with the upper extremity of the front wall substantially lower than that of the back wall, it becomes difficult, almost to the point of impossibility, to install the sign clip “backwards” without being immediately aware of it. More importantly, once the store clerk is made aware that the “short” wall of the clip is to be positioned on the outside of the panel 12, there is little occasion to install the clip improperly. If the clip is in fact installed improperly on occasion, it is so immediately evident that the installation does not “look right” that the clerk will rarely be unaware of an incorrect installation.

As reflected in FIG. 2, when the clip is installed on the upper margins of the label holder front panel 12, the retaining ribs 36 are in at least light contact with the front surface of the panel 12. Desirably, the ribs 36 are angled slightly upwardly, which both facilitates application of the clip on to the panel 12, and somewhat inhibits its removal.

As will be understood, when the clip is installed on the panel 12, and no sign clip has been inserted, the flexible ribs 36 will tend to hold the clip in place. However, when a sign card 19 is inserted between the flexible ribs 36 and the front surface of the panel 12, the frictional grip of the ribs on the front surface of the panel is lost and the clip is now restrained by the friction of the sign card 19 against the front surface of the panel 12, which is a much lower holding force. Accordingly, as an additional feature of the present invention, an auxiliary retaining rib 39 is provided on the back wall 32 of the sign clip, as a coextruded rib of soft vinyl material, similar to the soft material of the flexible retaining ribs 36. The auxiliary retaining rib 39 preferably is positioned between the upper and lower flexible ribs 36 and projects a relative minimal distance (e.g. 0.015 inch) in a forward direction, sufficient to provide contact with the back surface 40 of the panel 12, as shown in FIG. 2. Accordingly, even when a sign card 19 is inserted under the front portion of the clip, the clip is reliably frictionally retained on the label holder panel 12 by means of the rib 39.

The device of the invention solves significant practical problems associated with the use of sign clip devices in a typical store environment by making it difficult for careless store employees to utilize the clip in an improper manner, and also to minimize the potential for accidental dislodgment of the clip even after its proper installation.

It should be understood, of course, that the specific forms of the invention herein illustrated and described are intended to be representative only, as certain changes may be made therein without departing from the clear teachings of the disclosure. Accordingly, reference should be made to the following appended claims in determining the full scope of the invention.

I claim:

1. In the combination of (1) an extruded plastic label holder comprising front and back panels joined at bottom edges thereof and forming a pocket for holding labels and (2) a sign clip of generally inverted U-shaped cross sectional configuration removably mounted on an upper edge of said front panel, the improvement characterized by
(a) said sign clip having spaced apart front and back walls and an upper wall joining upper portions of said front and back walls,
(b) said upper wall extending from the upper portion of said back wall in a downward and forward direction to the upper portion of said front wall, whereby said front wall upper portion is positioned substantially below said back wall upper portion,
(c) said front wall having at least one integral, rearwardly extending, flexible, flap-like retention rib formed of soft plastic material and extending over the length of said front wall and engageable with a front surface portion of the label holder front panel for reception and retention of an upper edge portion of a sign card.

2. An improvement according to claim 1, wherein
(a) the back wall of said sign clip is formed with a projecting rib of soft plastic material extending over the length of the clip and positioned to have gripping contact with a back surface portion of said label holder front panel.

3. An improvement according to claim 1, wherein
(a) the upper wall of said sign clip is of arcuate configuration and merges generally tangentially with upper edge portions of said sign clip front wall.

4. In the combination of (1) an extruded plastic label holder comprising a label-engaging panel having an upper edge and (2) a sign clip of generally inverted U-shaped cross sectional configuration removably mounted on said upper edge, the improvement characterized by
(a) said sign clip having spaced apart front and back walls and an upper wall joining upper portions of said front and back walls,
(b) said upper wall extending from the upper portion of said back wall in a downward and forward direction to the upper portion of said front wall, whereby said front wall upper portion is positioned substantially below said back wall upper portion,
(c) said front wall having at least one integral, rearwardly extending, flexible, flap-like retention rib formed of soft plastic material and extending over the length of said front wall and engageable with a front surface portion of the label holder panel for reception and retention of an upper edge portion of a sign card.

5. An improvement according to claim 4, wherein
(a) the back wall of said sign clip is formed with a projecting rib of soft plastic material extending over the length of the clip and positioned to have gripping contact with a back surface portion of said label engaging panel.

6. In the combination of (1) an extruded plastic label holder comprising front and back panels joined at bottom edges thereof and forming a pocket for holding labels and (2) a sign clip of generally inverted U-shaped cross sectional configuration removably mounted on an upper edge of said front panel, the improvement characterized by
(a) said sign clip having spaced apart front and back walls and an upper wall joining upper portions of said front and back walls,
(b) said front, back and upper walls being a externally assymetrical configuration to facilitate installation of the sign clip with its said front wall positioned in front of said front panel,
(c) said front wall having at least two vertically spaced, integral, rearwardly extending, flexible, flap-like retention ribs formed of soft plastic material and extending over the length of said front wall,
(d) said retention ribs being engageable with a front surface portion of the label holder front panel for reception and retention of an upper edge portion of a sign card,
(e) the back wall of said sign clip being formed with a projecting rib of soft plastic material extending over the length of the clip and positioned to have gripping contact with a back surface portion of said label engaging panel.

7. An improvement according to claim 6, wherein
(a) said projecting rib is vertically positioned at a level intermediate said flap-like retention ribs.
